(19) United States
(12) Patent Application Publication
(10) Pub. No.: US 2023/0189889 A1
(43) Pub. Date: Jun. 22, 2023

(54) Aerosol Generating System

(71) Applicant: JT International SA, Geneva (CH)

(72) Inventor: Claude Zominy, Copponex (FR)

(73) Assignee: JT International SA, Geneva (CH)

(21) Appl. No.: 17/927,409

(22) PCT Filed: May 26, 2021
(86) PCT No.: PCT/IB2021/054586

§ 371 Date: Nov. 23, 2022

(30) Foreign Application Priority Data
May 28, 2020 (EP) 20177090.6

(51) Int. Cl. A24F 40/46; A24F 40/10; A24F 40/42; A24F 40/44; H05B 3/42

(52) U.S. Cl. CPC A24F 40/46; A24F 40/10; A24F 40/42; A24F 40/44; H05B 3/42

(57) ABSTRACT

An aerosol generating system includes a frusto-conically shaped heating element configured to generate aerosol by evaporating a vaporizable material on a convex slanted surface, and a capsule configured to contain vaporizable material, the capsule including a frusto-conically shaped cavity with a concave slanted surface configured to mate with the heating element. The system further includes a layer of a wick, a mesh or another type of porous element having a thickness configured to fill at least a part of a gap between the convex and concave surfaces when the heating element is mated with the cavity. A diameter of the top surface of the heating element is configured to be smaller than a diameter of the bottom surface of the cavity such that the gap between the convex and concave surfaces corresponds to the thickness of the porous element when the top surface is in contact with the bottom surface.

### FIELD OF THE INVENTION

The present disclosure relates to elements for an aerosol generating system and for producing an aerosol or vapor for inhalation by a user. The present disclosure relates more particularly to an aerosol generating system with a conically-shaped heating element and a corresponding vaporizable material cartridge for holding an e-liquid substance for producing an aerosol or vapor.

### BACKGROUND

The use of aerosol generating systems, also known as e-cigarettes, e-cigs (EC), electronic nicotine delivery systems (ENDS), electronic non-nicotine delivery systems (ENNDS), electronic smoking devices (ESDs), personal vaporizers (PV), inhalation devices, vapes, which can be used as an alternative to conventional smoking articles such as lit-end cigarettes, cigars, and pipes, is becoming increasingly popular and widespread. The most commonly used e-cigarettes are usually battery powered and use a resistance heating element to heat and atomize a liquid containing nicotine and/or flavorants (also known as e-cigarette liquid, e-cig liquids, e-liquid, juice, vapor juice, smoke juice, e-juice, e-fluid, vape oil), to produce an aerosol (also called vapor) which can be inhaled by a user.

In the conventional e-cigarettes described above, the liquid is put into contact with a resistance heating element after flowing through small channels, usually formed in a wicking, porous, element, where it is heated and vaporized. The flowing is realized for example via a wick, a mesh or another type of porous element, which has a plurality of small channels that transport the liquid from a reservoir to the heating element. This heating element together with the porous element, a reservoir that contains the e-liquid, and a mouthpiece may be arranged within a disposable capsule, cartridge or pod, that is discarded or refilled once the e-liquid has been consumed by the user, and usually removably connects to a main body that includes a rechargeable battery.

A general problem when designing an e-cigarette system is to reduce the consumable part of the system to an affordable and sustainable portion. Therefore, it is sometime desirable to design the e-cigarette system in such way that various components thereof may be individually replaced. The form factor of the various components of the system thus needs to be selected and controlled to ensure an optimal performance of the overall system once assembled.

One critical aspect is to ensure a tight contact between the heating element and the wicking element to provide a good heat conduction therebetween.

Another important aspect is to ensure an optimal vaporizable material flow inside the wicking element, requiring that the wicking element is not geometrically constrained (compressed) during the assembly even though the heat conduction requirement requires a tight contact, both requirements being conflicting.

A specific type of aerosol generating systems makes use of a conically-shaped heating element, and a correspondingly designed capsule of smoking substance that fits on the conically shaped heating element.

US patent publication US10206430 B2 discloses a capsule containing a plant-based, solid or semi-solid aerosol generating material, the capsule comprising a shell having a thin-walled external side wall and a thin-walled base with a frusto-conical shaped recess positioned centrally therein and configured to match a frusto-conical shaped heater when the capsule is inserted into an aerosol-generating device comprising the heater. In the aerosol generating system disclosed in US10206430 B2, the heater never contacts the aerosol-generating substrate directly to generate the aerosol but only the outer shell of the capsule, which dampens and homogenizes the heat transfer to the solid material therein. Such solution is however not applicable to liquid-based aerosol generating system, wherein the liquid material needs to be contacted with the heater directly to provide instant and homogenous vaporization of the liquid components.

EP2984952A1 discloses an atomizer for an electronic cigarette, comprising a housing defining a liquid chamber for storing tobacco liquid; and a mouthpiece arranged at a first end of the housing. The mouthpiece assembly defines an air passage and a backflow chamber. The backflow chamber comprises a closed bottom end away from the housing, and an open near end adjacent to the housing, the open end being in communication with the air passage. In addition to the liquid chamber, the housing comprises a conically shaped porous liquid conducting component that sticks out of the housing towards the open near end of the backflow chamber, and a heating wire that is wound around the porous liquid conducting component. Hence the housing gathers a liquid storing chamber, a liquid conducting element and a heating wire as one unit, namely the housing, which makes it inconvenient to simply change or refill the liquid, or replace the heating element independently from the liquid storing chamber.

One aim of the invention is to address the deficiencies of the prior art to provide an improved aerosol-generating system, in particular for generating aerosols from vaporizable material contained in consumable capsules or cartridges.

### SUMMARY

It is therefore one aspect of the present disclosure to provide an aerosol generating system comprising a frusto-conically shaped heating element configured to generate the aerosol by evaporating a vaporizable material on a slanted surface of said conically shaped heating element, and a vaporizable material capsule configured to contain a vaporizable material, whereby the vaporizable material capsule comprises a frusto-conically shaped contacting element having a slanted surface configured to mate with the frusto-conically shaped heating element in use. A diameter D1 of a smallest base surface of the frusto-conically shaped heating element is configured to be smaller than a diameter D2 of a smallest base surface of the frusto-conically shaped contacting element of the capsule such that a gap of a determined thickness TH is arranged between the respective slanted surfaces of the heater element and the capsule when the base surfaces of the frusto-conically shaped heating element and contacting element of the capsule are contacted to each other. An interfacing layer is arranged in said gap contacting the slanted surfaces of both the heating element and contacting element, the interfacing layer comprising a porous material configured to wick vaporizable material from the slanted surface of the contacting element to the slanted surface of the heating element.

In a preferred embodiment, the slanted surface of the heating element defines an inclination angle IA with the base surface thereof, and the first diameter D1 is obtained from the determined thickness TH and the inclination angle IA according to the following formula:

$$\text{D1=D2} - 2 \left(\text{TH} / sin \left(180 - \text{IA}\right)\right) .$$

In a further preferred embodiment, the frusto-conically shaped heating element is a male element and the frusto-conically shaped contacting element of the capsule is a female element.

In a further preferred embodiment, the frusto-conically shaped heating element is a female element and the frusto-conically shaped contacting element of the capsule is a male element.

In a further preferred embodiment, the female element is a frusto-conically shaped cavity extending along a longitudinal axis of the capsule from an insertion opening of diameter D4 to the smallest base of the contacting element, wherein D4>D2.

In a further preferred embodiment, the female element is a frusto-conically shaped cavity extending along a longitudinal axis of the heating element from an insertion opening of diameter D3 to the smallest base of the heating element, wherein D3>D1.

In a further preferred embodiment, a largest base of the male element has a diameter D5 equal to the diameter of the opening of the female element.

In a further preferred embodiment, the male element has a height HE that is greaterthan a depth CA of the female element.

In a further preferred embodiment, the interfacing layer comprises a mesh and/or a wicking material.

In a further preferred embodiment, the mesh is made of a metal or a metallic alloy.

In a further preferred embodiment, the interfacing layer is compressible.

In a further preferred embodiment, the interfacing layer is secured to the slanted surface of the contacting element.

In a further preferred embodiment, the interfacing layer is removably secured to the slanted surface of the contacting element.

In a further preferred embodiment, the slanted surfaces of the heating element and contacting element of the capsule have substantially a same profile.

In a further preferred embodiment, the heating element is electrically connected to a power source arranged in a body part of the aerosol generating system.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 schematically illustrates an example embodiment of an aerosol generating system according to the invention; and

FIG. 2 show a magnified portion of the system from FIG. 1.

Herein, identical reference numerals are used, where possible, to designate identical elements that are common to the Figures. Also, the images are simplified for illustration purposes and may not be depicted to scale.

### DETAILED DESCRIPTION OF PREFERRED EMBODIMENTS

In the present detailed description of preferred embodiment, the term vaporizable material capsule will be used to designate any one of a consumable, cartridge, capsule or article CR that includes a chamber or reservoir containing or holding at least one vaporizable material. The term vaporizable material will be used to also designate any material that is vaporizable at a temperature up to 400° C., preferably up to 350° C. for example aerosol generating liquid, gel, wax and the like.

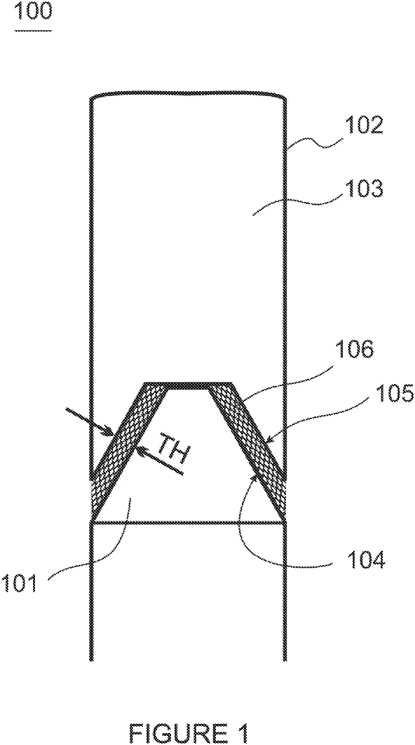

An exemplary embodiment of an aerosol generating system 100 according to the present disclosure is shown, for instance, in FIG. 1. FIG. 1 depicts an exemplary schematic view of the aerosol generating system 100 that comprises a frusto-conically shaped heating element 101 and a vaporizable material capsule 102, both illustrated in a symbolic representation.

The aerosol generating system 100 is, for example, to be used in or included in an aerosol generating device, an inhalation device or an electronic cigarette.

The frusto-conically shaped heating element 101 is configured in the represented example as a male component formed as a solid frustum to generate an aerosol (the aerosol is not represented in FIG. 1) by evaporating vaporizable material 103 on a slanted surface 104. The process of evaporating vaporizable material to generate the aerosol is well known in the art and will not be described herein in more detail.

The vaporizable material capsule 102 is configured to contain a vaporizable material 103, which in use may flow out towards the slanted surface 104 for example through at least one hole operated in a wall of the vaporizable material capsule facing the slanted surface 104 (hole not illustrated in FIG. 1). The vaporizable material capsule 102 comprises a frusto-conically shaped contacting element in the form of a cavity delimited by a slanted surface 105 configured to mate with the frusto-conically shaped heating element 101.

An interfacing layer of a porous material 106 is arranged in between the slanted surface 104 of the heating element 101 and the slanted surface 105 of the cavity.

Said slanted surfaces 104, 105 may have substantially a same profile, which means that they run substantially parallel to each other at the time of mating between the heating element 101 and the vaporizable material capsule 102.

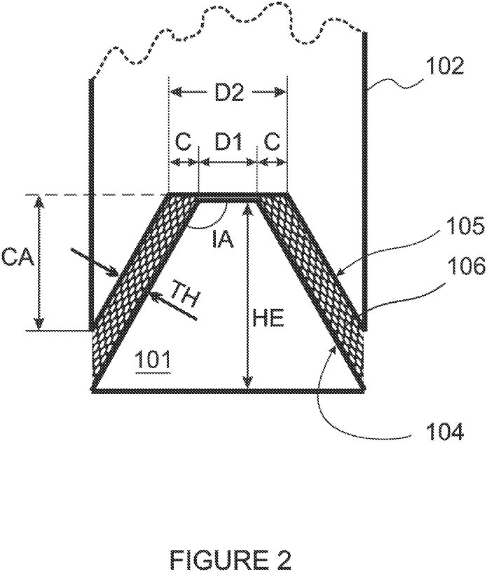

FIG. 2 is a magnified part of FIG. 1 showing details of the frusto-conically shaped heating element 101, the vaporizable material capsule 102 and the layer of mesh 106. The frusto-conically shaped cavity of the vaporizable material capsule 102 has a depth CA, and a circular bottom surface with a second diameter D2. The frusto-conically shaped heating element 101 has a circular top surface with a first diameter D1, which is obviously smaller than the second diameter D2, such that a gap between the slanted surface 104 and the slanted surface 105 is provided when the base surfaces of the heating element and contacting element are mated to each other, the gap having a determined thickness TH. The interfacing layer 106 is thus arranged and configured to fill the gap in use at the time when said base surfaces contact each other, in order to provide a wicking component capable of allowing vaporizable material to flow from the capsule reservoir to the heating element slanted surface.

More specifically, the slanted surface 104 may define an inclination angle IA with the base surface of the heating element, which of course is the same angle as that defined between the slanted surface 106 and the base surface of the cavity. The difference between the second diameter D2 and the first diameter D1 is equal to 2C, represented as 2 portions C on each side of the first diameter D1 in FIG. 2.

In direct application of trigonometric knowledge, the value of C is given by the following formula:

$$\text{C} = \text{TH} / sin \left(180 - \text{IA}\right)$$

Accordingly, the first diameter D1 may be obtained by the following formula:

$$\text{D1} = \text{D2} - \text{2C} = \text{D2} - \text{2TH} / sin \left(180 - \text{IA}\right)$$

By applying these values to the top surface and the bottom surface, at the time of manufacturing, it becomes possible to precisely position the frusto-conically shaped heating element 101 inside the frusto-conically shaped cavity of the vaporizable material capsule 103 with a layer of mesh 106 having the determined thickness TH, by simply bringing the top surface in contact with the bottom surface. One advantage linked to the geometrical properties of the elements is that no compression or deformation is applied to the interfacing layer 106, because the frusto-conically shaped heating element 101 is simply centered inside the frusto-conically shaped cavity of the vaporizable material capsule 103 at the time of mating without excessively compressing the interfacing layer 106 through the slanted surface 104, the gap having been adjusted by proper dimensioning to correspond to the determined thickness TH. The interfacing layer 106 is preferably comprised of a porous material woven or non-woven material wrapped with a metallic mesh, for example of stainless steel or copper, which mesh advantageously provides mechanical resistance to compression while ensuring in use proper heat conduction from the heaterto the porous material containing vaporizable material, thus allowing pre-heating of the vaporizable material in the material before reaching the slanted surface of the heating element. Depending on the mesh properties, the interfacing layer 106 may be partially compressible, in order to ensure proper contacting between the capsule and heating element.

Preferably a height HE of the frusto-conically shaped heating element 101 is equal orgreaterthan the depth CA. This allows to maximize the length of the gap between the convex slanted surface 104 and the concave slanted surface 105, hence increasing the possible surface of the layer of mesh 106.

In an alternative embodiment of the invention not illustrated in the figures, the geometrical configuration is inverted, meaning that the frusto-conically shaped heating element is configured as a cavity, and the vaporizable material capsule is configured to have a convex frusto-conically shaped part configured to mate with the frusto-conically shaped heating element. This provides similar technical effects and advantages of easily and precisely centering the e-liquid capsule in the corresponding cavity of the heating element while avoiding any compression and/or deformation of the layer of the wick, the mesh or other type of porous element that fills at least a part of the gap.

Implementations described herein are not intended to limit the scope of the present disclosure but are just provided to illustrate possible realizations.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above described embodiments may be included in any other embodiment described herein.

1. An aerosol generating system comprising:
a frusto-conically shaped heating element configured to generate aerosol by evaporating a vaporizable material on a slanted surface of the frusto-conically shaped heating element, and
a vaporizable material capsule configured to contain a vaporizable material, whereby the vaporizable material capsule comprises a frusto-conically shaped contacting element having a slanted surface configured to mate with the frusto-conically shaped heating element in use,
wherein a diameter D1 of a smallest base surface of the frusto-conically shaped heating element is configured to be smaller than a diameter D2 of a smallest base surface of the frusto-conically shaped contacting element of the capsule such that a gap of a determined thickness TH is arranged between the respective slanted surfaces of the heating element and the capsule when the base surfaces of the frusto-conically shaped heating element and contacting element of the capsule are contacted to each other, and
wherein an interfacing layer is arranged in the gap contacting the slanted surfaces of both the heating element and the contacting element, the interfacing layer comprising a porous material configured to wick vaporizable material from the slanted surface of the contacting element to the slanted surface of the heating element.

2. The aerosol generating system of claim 1, wherein:
the slanted surface of the heating element defines an inclination angle IA with the base surface thereof, and the first diameter D1 is obtained from the determined thickness TH and the inclination angle IA according to the following formula:
$$\text{D1 = D2 - 2(TH/sin(180-IA))} \text{.}$$
.

3. The aerosol generating system according to claim 1, wherein the frusto-conically shaped heating element is a male element and the frusto-conically shaped contacting element of the capsule is a female element.

4. The aerosol generating system according to claim 1, wherein the frusto-conically shaped heating element is a female element and the frusto-conically shaped contacting element of the capsule is a male element.

5. The aerosol generating system according to claim 3, wherein the female element is a frusto-conically shaped cavity extending along a longitudinal axis of the capsule from an insertion opening of diameter D4 to the smallest base surface of the contacting element, wherein D4>D2.

6. The aerosol generating system according to claim 4, wherein the female element is a frusto-conically shaped cavity extending along a longitudinal axis of the heating element from an insertion opening of diameter D3 to the smallest base surface of the heating element, wherein D3>D1.

7. The aerosol generating system according to claim 5, wherein a largest base of the male element has a diameter D5 equal to the diameter D4 of the opening of the female element.

8. The aerosol generating system according to claim 3, wherein the male element has a height HE that is greater than a depth CA of the female element.

9. The aerosol generating system according to claim 1, wherein the interfacing layer comprises a mesh and/or a wicking material.

10. The aerosol generating system according to claim 1, wherein the interfacing layer comprises a mesh made of a metal or a metallic alloy.

11. The aerosol generating system according to claim 1, wherein the interfacing layer is compressible.

12. The aerosol generating system according to claim 1, wherein the interfacing layer is secured to the slanted surface of the contacting element.

13. The aerosol generating system according to claim 1, wherein the interfacing layer is removably secured to the slanted surface of the contacting element.

14. The aerosol generating system of claim 1, wherein:
the slanted surfaces of the heating element and the contacting element of the capsule have substantially a same profile.

15. The aerosol generating system according to claim 1, wherein the heating element is electrically connected to a power source arranged in a body part of the aerosol generating system.

16. The aerosol generating system according to claim 6, wherein a largest base of the male element has a diameter D5 equal to the diameter D3 of the opening of the female element.

17. The aerosol generating system according to claim 4, wherein the male element has a height HE that is greater than a depth CA of the female element.
